(19) United States
(12) Patent Application Publication
(10) Pub. No.: US 2026/0177365 A1
(43) Pub. Date: Jun. 25, 2026

(54) ELECTRIC CIRCUIT BREAKER DEVICE

(71) Applicant: Daicel Corporation, Osaka (JP)

(72) Inventor: Katsuhiro NAKAHASHI, Tokyo (JP)

(73) Assignee: Daicel Corporation, Osaka (JP)

(21) Appl. No.: 18/836,805

(22) PCT Filed: Feb. 15, 2023
(86) PCT No.: PCT/JP2023/005148

§ 371 Date: Aug. 8, 2024

(30) Foreign Application Priority Data
Feb. 15, 2022 (JP) 2022-021607

(51) Int. Cl. F42B 12/74; F41B 11/89; F42B 10/26; F42B 10/38; F42B 12/34

(52) U.S. Cl. CPC F42B 12/74; F41B 11/89; F42B 10/26; F42B 10/38; F42B 12/34

(57) ABSTRACT

An electric circuit breaker device including: an igniter provided in a housing; a projectile formed in the housing and disposed in an accommodating space extending in one direction; a conductor piece provided in the housing and forming a portion of an electric circuit, the conductor piece including, in a part of the conductor piece, a cutoff portion disposed crossing the accommodating space and configured to be cut off by the projectile; and an arc-extinguishing region provided in the accommodating space and provided with a coolant material. The projectile includes a first projectile configured to be projected by energy received from the igniter and reach a stop position, and a second projectile configured to be separated from the first projectile, cut off the cutoff portion from the conductor piece, and press, into the coolant material disposed in the arc-extinguishing region, the cutoff portion having been cut off.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system in which the electric circuit is mounted, thereby urgently interrupting the continuity of the electric circuit. Electric circuit breaker devices have been proposed in which, according to one aspect thereof, a projectile is moved at high speed by energy applied from an igniter or the like to forcibly and physically cut a conductor piece that forms a portion of an electric circuit (refer to Patent Documents 1 and 2 and the like, for example). Further, in recent years, electric circuit breaker devices applied to electric vehicles equipped with a high-voltage power source are becoming increasingly important.

### CITATION LIST

### Patent Document

Patent Document 1: JP 2014-49300 A
Patent Document 2: JP 2018-6082 A

### SUMMARY OF INVENTION

### Technical Problem

In an electric circuit breaker device, an arc is likely to be generated when a conductor piece forming a portion of an electric circuit is cut. When an arc is generated, the electric circuit cannot be interrupted quickly, and thus the electric circuit breaker device is required to quickly extinguish the generated arc. In order to quickly extinguish the generated arc, it is necessary to move the cut conductor piece to a position away from the cutting position.

The technique of the present disclosure has been made in view of the circumstances described above, and an object thereof is to provide an electric circuit breaker device capable of quickly extinguishing an arc during actuation.

### Solution to Problem

In order to solve the above problem, the following means is adopted.

That is, a first aspect is an electric circuit breaker device including: an igniter provided in a housing; a projectile formed in the housing and disposed in an accommodating space extending in one direction, the projectile being configured to be projected along the accommodating space by energy received from the igniter; a conductor piece provided in the housing and forming a portion of an electric circuit, the conductor piece including, in a part of the conductor piece, a cutoff portion disposed crossing the accommodating space and configured to be cut off by the projectile; and an arc-extinguishing region provided in the accommodating space and provided with a coolant material, in which the projectile includes a first projectile configured to be projected by energy received from the igniter and reach a stop position, and a second projectile configured to be separated from the first projectile, cut off the cutoff portion from the conductor piece, and press, into the coolant material disposed in the arc-extinguishing region, the cutoff portion having been cut off.

A second aspect is the electric circuit breaker device in which the second projectile is attached to the first projectile prior to actuation of the igniter, and is projected together with the first projectile by energy received from the igniter.

A third aspect is the electric circuit breaker device in which the second projectile is attached to the first projectile with the second projectile positioned coaxially with the first projectile, prior to actuation of the igniter.

A fourth aspect is the electric circuit breaker device in which the first projectile includes an attachment recessed portion in which the second projectile is attached, and the second projectile has a cutting surface disposed facing the cutoff portion prior to actuation of the igniter, the cutting surface being used to cut the cutoff portion.

A fifth aspect is the electric circuit breaker device in which the first projectile includes a communication path through which energy received from the igniter is guided to a pressure receiving portion of the second projectile attached in the attachment recessed portion.

### Advantageous Effects of Invention

According to the present disclosure, it is possible to provide an electric circuit breaker device capable of quickly extinguishing an arc that is generated during actuation.

### BRIEF DESCRIPTION OF DRAWINGS

FIG. 1 is a view illustrating an internal structure of a breaker device.

FIG. 2 is a top view of a conductor piece.

FIG. 3 is an exploded view of a projectile 30.

FIG. 4 is a view illustrating an actuation situation of the breaker device.

FIG. 5 is a view illustrating an internal structure of the breaker device in a case where no communication path exists.

FIG. 6 is an exploded view of the projectile 30 in a case where no communication path exists.

FIG. 7 is a view illustrating an actuation situation of the breaker device in a case where no communication path exists.

### DESCRIPTION OF EMBODIMENTS

An electric circuit breaker device according to an embodiment of the present disclosure will be described below with reference to the drawings. Note that each of the configurations, combinations thereof, and the like in the embodiments are an example, and various additions, omissions, substitutions, and other changes of the configurations may be made as appropriate without departing from the spirit of the present disclosure. The present disclosure is not limited by the embodiments and is limited only by the claims.

### Configuration

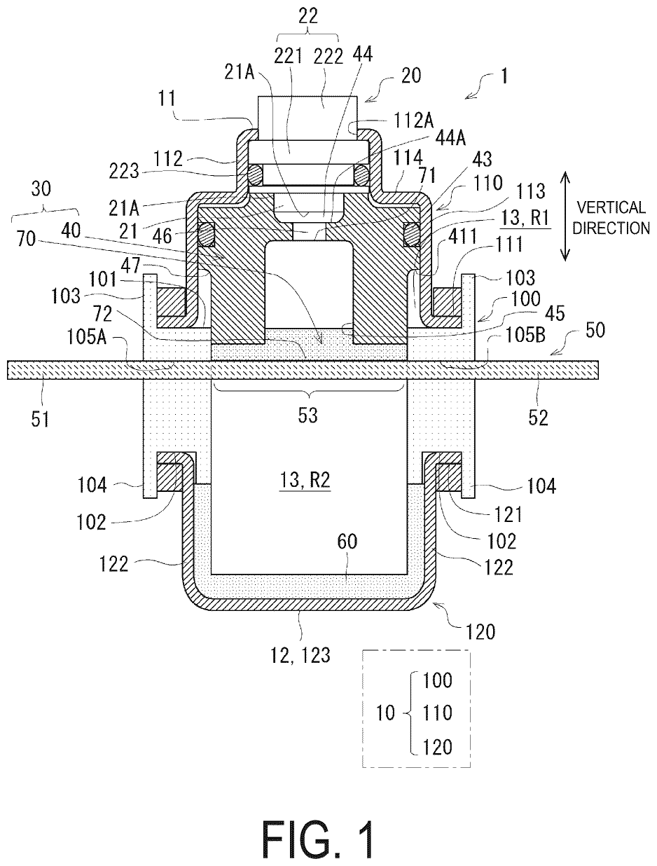

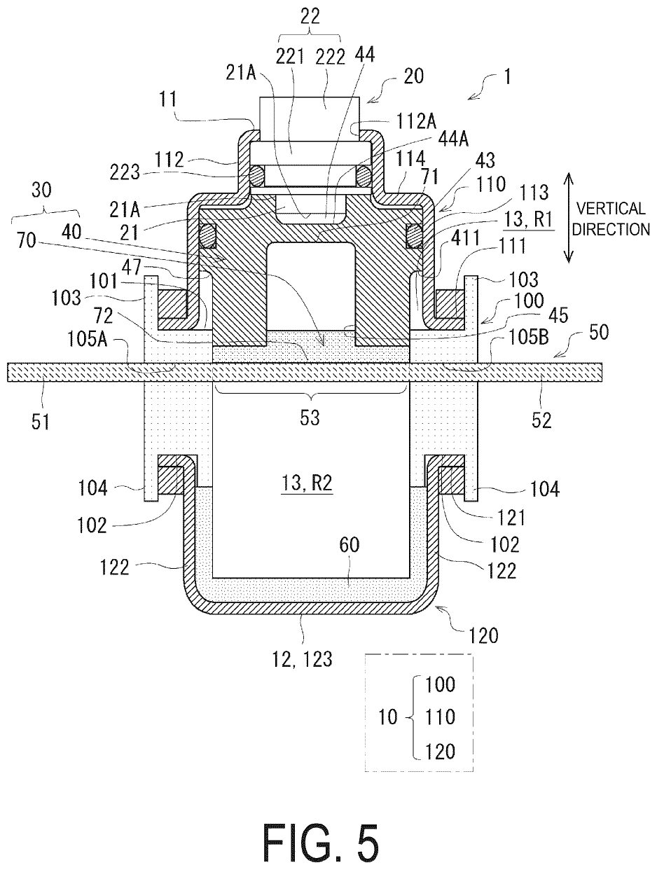

FIG. 1 is a view illustrating an internal structure of an electric circuit breaker device (hereinafter simply referred to as the “breaker device”) 1 according to an embodiment. The breaker device 1 is a device that interrupts an electric circuit included in a vehicle, an electric home appliance, or the like when an abnormality occurs in the electric circuit or in a system including a battery (lithium ion battery, for example) of the electric circuit, thereby preventing great damage, for example. In the present specification, a cross section in the height direction illustrated in FIG. 1 (direction in which an accommodating space 13 described later extends) is referred to as a vertical cross section of the breaker device 1, and a cross section in a direction orthogonal to the vertical cross section is referred to as a transverse cross section of the breaker device 1. FIG. 1 illustrates a state prior to actuation of the breaker device 1. FIG. 5 is a view illustrating an internal structure of the breaker device in a case where no communication path exists, and is similar to FIG. 1 except for the presence or absence of the communication path.

The breaker device 1 includes a housing 10 as an outer shell member, an igniter 20, a projectile 30, a conductor piece 50, and a coolant material 60. The housing 10 includes the accommodating space 13 that extends in a direction from a first end portion 11 on an upper end side to a second end portion 12 on a lower end side. This accommodating space 13 is a space formed in a straight line, making the projectile 30 movable, and extends along a vertical direction of the breaker device 1. However, in the present specification, the vertical direction of the breaker device 1 merely indicates a relative positional relationship among the elements in the breaker device 1 for convenience of description of the embodiment.

As illustrated in FIG. 1, the accommodating space 13 formed inside the housing 10 accommodates the projectile 30. Note that although described in detail later, the projectile 30 includes a first projectile 40 and a second projectile 70 attached to the first projectile 40 in a pre-actuation initial state prior to actuation of the breaker device 1.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially prismatic outer shape. However, the shape of the housing body 100 is not particularly limited. The housing body 100 includes a cavity portion formed therethrough along the vertical direction. This cavity portion forms a portion of the accommodating space 13. Furthermore, the housing body 100 has an upper surface 101 to which a flange portion 111 of the top holder 110 is fixed and a lower surface 102 to which a flange portion 121 of the bottom container 120 is fixed. In the present embodiment, an upper tubular wall 103 having a tubular shape is provided erected upward from the upper surface 101 on the outer circumferential side of the upper surface 101 in the housing body 100. In the present embodiment, the upper tubular wall 103 has a rectangular tubular shape, for example, but may have other shapes. On the outer circumferential side of the lower surface 102 in the housing body 100, a lower tubular wall 104 having a tubular shape is provided suspended downward from the lower surface 102. In the present embodiment, the lower tubular wall 104 has a rectangular tubular shape, for example, but may have other shapes. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped cylindrical tubular shape with a hollow inside. The top holder 110 includes a small diameter cylinder portion 112 positioned on the upper side (first end portion 11 side), a large diameter cylinder portion 113 positioned on the lower side, a connection portion 114 connecting these, and the flange portion 111 extending outward from a lower end of the large diameter cylinder portion 113. For example, the small diameter cylinder portion 112 and the large diameter cylinder portion 113 are coaxially disposed and have cylindrical tubular shapes. The large diameter cylinder portion 113 has a diameter slightly larger than that of the small diameter cylinder portion 112. The connection portion 114 extends in a radial direction of the small diameter cylinder portion 112 and the large diameter cylinder portion 113, thereby connecting them to each other.

The contour of the flange portion 111 in the top holder 110 has a substantially quadrangular shape that fits inside the upper tubular wall 103 in the housing body 100. For example, the flange portion 111 may be integrally fastened to the upper surface 101 in the housing body 100 using a screw or the like, or may be fixed thereto by a rivet or the like, in a state of being disposed inside the upper tubular wall 103. Further, the top holder 110 may be bonded to the housing body 100 in a state where a sealant is applied between the upper surface 101 of the housing body 100 and a lower surface of the flange portion 111 in the top holder 110. This can increase airtightness of the accommodating space 13 formed in the housing 10. Further, instead of the sealant or in combination with the sealant, an O-ring may be interposed between the upper surface 101 of the housing body 100 and the flange portion 111 of the top holder 110 to increase the airtightness of the accommodating space 13.

The cavity portion formed inside the small diameter cylinder portion 112 in the top holder 110 functions as an accommodating space for accommodating a portion of the igniter 20 as illustrated in FIG. 1. Further, the cavity portion formed inside the large diameter cylinder portion 113 in the top holder 110 communicates with the cavity portion of the housing body 100 positioned below, and forms a portion of the accommodating space 13. The top holder 110 configured as described above can be formed from an appropriate metal member, such as stainless steel or aluminum, having excellent strength and durability, for example. However, a material for forming the top holder 110 is not particularly limited. Also, for the shape of the top holder 110, the above aspect is an example and other shapes may be adopted.

### Bottom Container

Next, the bottom container 120 will be described. The bottom container 120 has a substantially tubular bottomed shape with a hollow inside, and includes a side wall portion 122, a bottom wall portion 123 connected to a lower end of the side wall portion 122, and a flange portion 121 connected to an upper end of the side wall portion 122. The side wall portion 122 has, for example, a cylindrical tubular shape. The flange portion 121 extends outward from the upper end of the side wall portion 122. The contour of the flange portion 121 in the bottom container 120 has a substantially quadrangular shape that fits inside the lower tubular wall 104 in the housing body 100. For example, the flange portion 121 may be integrally fastened to the lower surface 102 in the housing body 100 using a screw or the like, or may be fixed thereto by a rivet or the like, in a state of being disposed inside the lower tubular wall 104. Here, the bottom container 120 may be bonded to the housing body 100 in a state where the sealant is applied between the lower surface 102 of the housing body 100 and an upper surface of the flange portion 121 in the bottom container 120. This can increase airtightness of the accommodating space 13 formed in the housing 10. Further, instead of the sealant or in combination with the sealant, an O-ring may be interposed between the lower surface 102 of the housing body 100 and the flange portion 121 of the bottom container 120 to increase the airtightness of the accommodating space 13.

Note that the above aspect regarding the shape of the bottom container 120 is an example, and other shapes may be adopted. Further, the cavity portion formed inside the bottom container 120 communicates with the housing body 100 positioned above, and forms a portion of the accommodating space 13. The bottom container 120 configured as described above can be formed from an appropriate metal member, such as stainless steel or aluminum, having excellent strength and durability, for example. However, a material for forming the bottom container 120 is not particularly limited. Further, the bottom container 120 may have a multilayer structure. For example, in the bottom container 120, an exterior portion facing the outside may be formed using an appropriate metal member, such as stainless steel or aluminum, having excellent strength and durability, and an interior portion facing the accommodating space 13 may be formed using an insulating member such as a synthetic resin. Of course, the entire bottom container 120 may be formed using an insulating member.

As described above, the housing 10 in the embodiment includes the housing body 100, the top holder 110, and the bottom container 120 that are integrally assembled, and the accommodating space 13 extending in the direction from the first end portion 11 to the second end portion 12 is formed inside the housing 10. The accommodating space 13 accommodates the igniter 20, the projectile 40, a cutoff portion 53 of the conductor piece 50, the coolant material 60, and the like described in detail below.

### Igniter

Next, the igniter 20 will be described. The igniter 20 is an electric igniter that includes an ignition portion 21 with an ignition charge, and an igniter body 22 including a pair of conduction pins (not illustrated) connected to the ignition portion 21. The igniter body 22 is surrounded by an insulating resin, for example. Further, tip end sides of the pair of conduction pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 positioned on the body portion 221.

The igniter body 22 is fixed to the small diameter cylinder portion 112 by press-fitting, for example, the body portion 221 to an inner circumferential surface of the small diameter cylinder portion 112. Further, a constricted portion having an outer circumferential surface recessed as compared with other locations is annularly formed along a circumferential direction of the body portion 221 at an axially intermediate portion of the body portion 221. An O-ring 223 is fitted into this constricted portion. The O-ring 223 is formed from, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a cylindrical tubular shape covering sides of the conduction pins, allowing connection with a connector of a power source.

As illustrated in FIG. 1, the ignition portion 21 of the igniter 20 is disposed facing the accommodating space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of conduction pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like can be adopted.

In actuation of the igniter 20, when an actuating current for igniting the ignition charge is supplied from the power source to the conduction pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodating space 13. More specifically, the combustion gas from the igniter cup is discharged into a recess 411 in a piston portion 41 described later of the projectile 40 disposed in the accommodating space 13.

### Conductor Piece

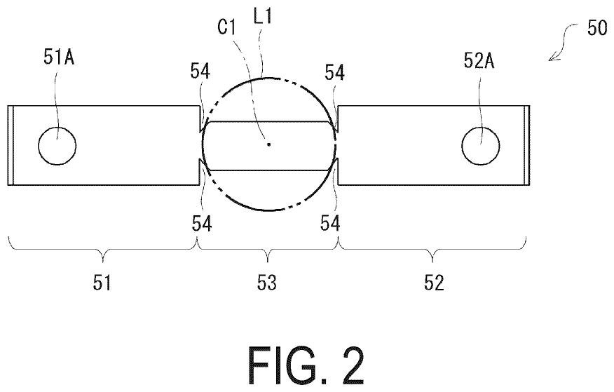

Next, the conductor piece 50 will be described. FIG. 2 is a top view of the conductor piece 50 according to the embodiment. The conductor piece 50 is a metal body having conductivity that constitutes a portion of the components of the breaker device 1 and, when the breaker device 1 is attached to a predetermined electric circuit, forms a portion of the electric circuit, and may be referred to as a bus bar. The conductor piece 50 can be formed from a metal such as copper (Cu), for example. However, the conductor piece 50 may be formed using a metal other than copper, or may be formed using an alloy of copper and another metal. Note that examples of metals other than copper included in the conductor piece 50 include manganese (Mn), nickel (Ni), and platinum (Pt).

In one aspect illustrated in FIG. 2, the conductor piece 50 is formed as an elongated flat plate piece as a whole, and includes a first connecting end portion 51 and a second connecting end portion 52 on both end sides, and the cutoff portion 53 positioned in an intermediate portion therebetween. The first connecting end portion 51 and the second connecting end portion 52 of the conductor piece 50 are provided with connection holes 51A and 52A, respectively. These connection holes 51A and 52A are used for connection with other conductors (lead wires, for example) in the electric circuit. Note that in FIG. 1, the connection holes 51A and 52A in the conductor piece 50 are not illustrated. The cutoff portion 53 of the conductor piece 50 is a site that is forcibly and physically cut by the projectile 30 (second projectile 70) to be described later and cut off from the first connecting end portion 51 and the second connecting end portion 52 when an abnormality such as an excessive current occurs in the electric circuit to which the breaker device 1 is applied. Notches (slits) 54 are formed at both ends of the cutoff portion 53 of the conductor piece 50, making it easy to cut and cut off the cutoff portion 53.

Here, various forms of the conductor piece 50 can be adopted, and a shape thereof is not particularly limited. While, in the example illustrated in FIG. 2, surfaces of the first connecting end portion 51, the second connecting end portion 52, and the cutoff portion 53 form the same surface, the form is not limited thereto. For example, the conductor piece 50 may be connected such that the cutoff portion 53 is orthogonal to or inclined relative to the first connecting end portion 51 and the second connecting end portion 52. Further, the planar shape of the cutoff portion 53 of the conductor piece 50 is not particularly limited, either. Of course, the shapes of the first connecting end portion 51 and the second connecting end portion 52 of the conductor piece 50 are not particularly limited, either. Further, the notches 54 in the conductor piece 50 can be omitted as appropriate.

Here, a pair of conductor piece holding holes 105A and 105B are formed in the housing body 100 according to the embodiment. The pair of conductor piece holding holes 105A and 105B extend in a transverse cross section direction orthogonal to the vertical direction (axial direction) of the housing body 100. More specifically, the pair of conductor piece holding holes 105A and 105B extend in a straight line across the cavity portion (accommodating space 13) of the housing body 100. The conductor piece 50 configured as described above is held by the housing body 100 in a state of being inserted through the pair of conductor piece holding holes 105A and 105B formed in the housing body 100. In the example illustrated in FIG. 1, the first connecting end portion 51 of the conductor piece 50 is held in a state of being inserted through the conductor piece holding hole 105A, and the second connecting end portion 52 is held in a state of being inserted through the conductor piece holding hole 105B. In this state, the cutoff portion 53 of the conductor piece 50 is positioned in the cavity portion (accommodating space 13) of the housing body 100. As described above, the conductor piece 50 attached to the housing body 100 is held orthogonally to the extending direction (axial direction) of the accommodating space 13 with the cutoff portion 53 crossing the accommodating space 13. Note that a reference sign L1 shown in FIG. 2 indicates an outer circumferential position of the second projectile 70 positioned on the conductor piece 50 in a state of being attached to the housing body 100 of the breaker device 1. In the present embodiment, the conductor piece 50 is installed and thus the outer circumferential position L1 of the second projectile 70 substantially overlaps the positions of the notches 54 positioned at both ends of the cutoff portion 53. In the present embodiment, for example, since a transverse cross-sectional area of the accommodating space 13 is larger than a transverse cross-sectional area of the cutoff portion 53, a gap is formed on the side of the cutoff portion 53.

### Coolant Material

Next, the coolant material 60 disposed in the accommodating space 13 in the housing 10 will be described. Here, as illustrated in FIG. 1, before actuation of the breaker device 1 (the igniter 20), the cutoff portion 53 of the conductor piece 50 in a state of being held in the pair of conductor piece holding holes 105A and 105B in the housing body 100 is laterally bridged across the accommodating space 13 of the housing 10. Hereinafter, within the accommodating space 13 of the housing 10 separated by the cutoff portion 53 of the conductor piece 50, a region (space) in which the projectile 30 is disposed is referred to as a “projectile initial arrangement region R1”, and a region (space) positioned on the opposite side of the projectile 30 is referred to as an “arc-extinguishing region R2”. Note that in the present embodiment, the transverse cross-sectional area of the accommodating space 13 is larger than the transverse cross-sectional area of the cutoff portion 53, and a gap is formed on the side of the cutoff portion 53. Therefore, the projectile initial arrangement region R1 and the arc-extinguishing region R2 in the accommodating space 13 are not completely isolated from each other by the cutoff portion 53, but communicate with each other via the gap. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodating space 13 is a region (space) for receiving the cutoff portion 53 cut off by the projectile 30 projected during actuation of the breaker device 1 (igniter 20). In this arc-extinguishing region R2, the coolant material 60 as an arc-extinguishing material is disposed. The coolant material 60 is a coolant material for removing thermal energy of the arc generated and the cutoff portion 53 when the projectile 30 cuts off the cutoff portion 53 of the conductor piece 50 and cooling the arc and the cutoff portion 53, thereby suppressing arc generation during cutting off of a current or thereby extinguishing (eliminating) the generated arc.

The arc-extinguishing region R2 of the breaker device 1 has significance as a space for receiving the cutoff portion 53 cut off from the first connecting end portion 51 and the second connecting end portion 52 of the conductor piece 50 and, at the same time, as a space for effectively extinguishing the arc generated when the cutoff portion 53 is cut off. Then, in order to effectively extinguish the arc generated when the cutoff portion 53 is cut off from the conductor piece 50, the coolant material 60 is disposed as an arc-extinguishing material in the arc-extinguishing region R2. As one aspect of the embodiment, the coolant material 60 is solid. The coolant material 60 is disposed, for example, on a side surface and a bottom portion of the bottom container 120. The inner circumferential surface of the coolant material 60 disposed on the side surface of the bottom container 120 has an inner diameter substantially corresponding to the inner diameter of the inner circumferential surface of the housing body 100, for example. The inner diameter of the inner circumferential surface of the coolant material 60 disposed on the side surface of the bottom container 120 is equal to the inner diameter of the inner circumferential surface of the housing body 100, for example. The coolant material 60 may be formed by, for example, molding an interwoven metal fiber into a desired shape. Examples of the metal fiber forming the coolant material 60 include an aspect in which at least any one of steel wool or copper wool is included. However, the above aspects in the coolant material 60 are examples, and the coolant material 60 is not limited to the above aspects. For example, the coolant material 60 may be powder or the like that is compression molded. The coolant material 60 may be not in a solid state but in a gel state. The coolant material 60 may be disposed not only at the side surface and the bottom portion of the bottom container 120 but also at other positions in the housing 10, such as the side surface (inner side) of the housing body 100, the side surface (inner side) of the top holder 110, and the side surface (outer side) of the first projectile 40. Disposing the coolant material 60 at many positions can extinguish the arc more effectively.

### Projectile

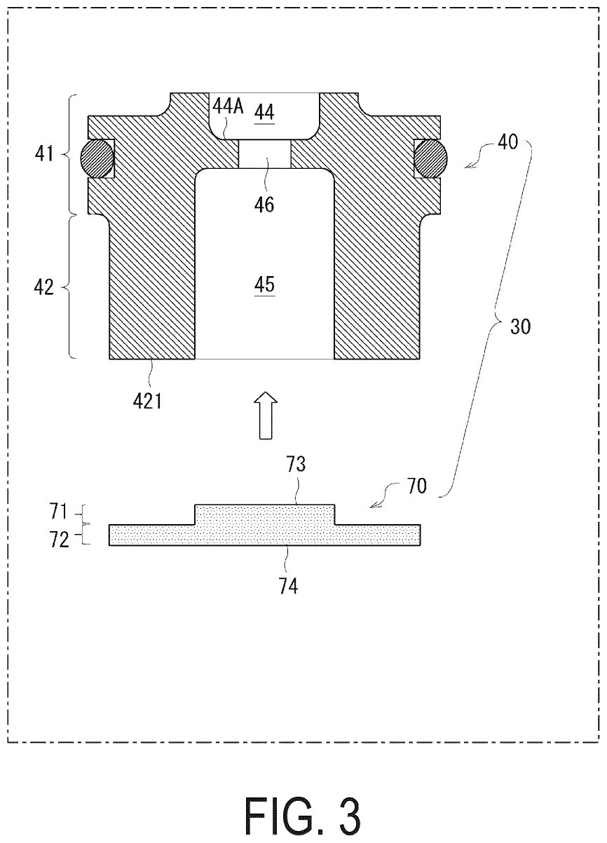

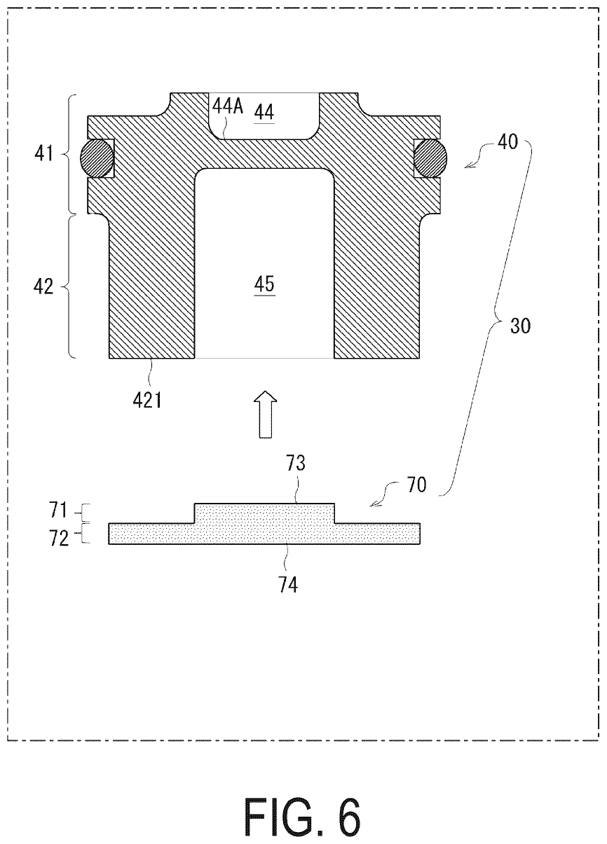

Next, the projectile 30 will be described. The projectile 30 includes the first projectile 40 and a second projectile 70. FIG. 3 is an exploded view of the projectile 30, illustrating the first projectile 40 and the second projectile 70 in a state of being separated from each other. The first projectile 40 and the second projectile 70 are formed from an insulating member such as a synthetic resin, for example. As illustrated in FIG. 3, the outer diameter of the second projectile 70 is substantially equal to the outer diameter of a rod portion 42 of the first projectile 40. FIG. 6 is an exploded view of the projectile 30 in a case where no communication path exists, and is similar to FIG. 3 except for the presence or absence of the communication path.

The first projectile 40 will be described. The first projectile 40 includes the piston portion 41 and the rod portion 42 connected to the piston portion 41. The piston portion 41 has a substantially circular columnar shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The shape of the piston portion 41 can be changed as appropriate according to the shape of the large diameter cylinder portion 113 and the like.

The rod portion 42 of the first projectile 40 is a rod-shaped member having an outer circumferential surface smaller in diameter than the piston portion 41, for example, and is integrally connected to a lower end side of the piston portion 41. Here, although the rod portion 42 in the present embodiment has a substantially cylindrical tubular shape, the shape thereof is not particularly limited. The diameter of the rod portion 42 is slightly smaller than the inner diameter of an inner circumferential surface of the housing body 100, for example. The outer circumferential surface of the rod portion 42 is guided along the inner circumferential surface of the housing body 100 during actuation of the breaker device 1.

Further, a recess 44, which is a recessed portion having a circular columnar shape, for example, is formed on an upper surface of the piston portion 41 in the first projectile 40. The recess 44 is configured to receive the ignition portion 21. A bottom surface of the recess 44 is formed as a first pressure receiving portion 44A that receives energy received from the igniter 20 during actuation of the igniter 20. Further, a constricted portion having an outer circumferential surface recessed as compared with other locations is annularly formed along a circumferential direction of the piston portion 41 at an axially intermediate portion of the piston portion 41. An O-ring 43 is fitted into this constricted portion. The O-ring 43 is formed from, for example, rubber (silicone rubber, for example) or a synthetic resin, and functions to increase airtightness between an inner circumferential surface in the large diameter cylinder portion 113 and the piston portion 41.

The lower end side of the first projectile 40 is provided with an attachment recessed portion 45 for accommodating and attaching a part of the second projectile 70. The attachment recessed portion 45 is formed in an aspect of opening in a lower end surface 421 of the rod portion 42 in the first projectile 40. In the example illustrated in FIGS. 1 and 3, the attachment recessed portion 45 has a circular columnar shape. The recess 44 and the attachment recessed portion 45 of the first projectile 40 are coaxially disposed and extend through a center axis of the first projectile 40. Furthermore, as illustrated in FIGS. 1 and 3, a communication path 46 that connects the recess 44 and the attachment recessed portion 45 to each other (allows communication between the recess 44 and the attachment recessed portion 45) is provided in the first projectile 40. The communication path 46 of the first projectile 40 is formed extending through the center axis of the first projectile 40. The communication path 46 is also disposed coaxially with both the recess 44 and the attachment recessed portion 45. As illustrated in FIGS. 5 and 6, the communication path 46 need not exist. That is, the recess 44 and the attachment recessed portion 45 need not communicate with each other.

Next, the second projectile 70 will be described. The second projectile 70 includes an upper portion 71 having a shape and size that allow accommodation in the attachment recessed portion 45 of the first projectile 40, and a lower portion 72 connected to the upper portion 71. The upper portion 71 of the second projectile 70 has a substantially circular columnar shape and has an outer diameter substantially corresponding to the inner diameter of the rod portion 42 (the diameter of the attachment recessed portion 45). For example, the diameter of the upper portion 71 may be slightly smaller than the inner diameter of the rod portion 42. The shape of the upper portion 71 can be changed as appropriate according to the shape of the attachment recessed portion 45 and the like. The upper portion 71 is a portion accommodated in the attachment recessed portion 45. The lower portion 72 of the second projectile 70 has a substantially circular columnar shape and has an outer diameter substantially corresponding to the outer diameter of the rod portion 42. The outer diameter (diameter) of the lower portion 72 is equal to the outer diameter of the rod portion 42, for example. The diameter of the lower portion 72 is slightly smaller than the inner diameter of the inner circumferential surface of the housing body 100, for example. That is, the diameter of the lower portion 72 is slightly smaller than the inner diameter of the inner circumferential surface of the coolant material 60 disposed on the side surface of the bottom container 120. During actuation of the breaker device 1, the outer circumferential surface of the lower portion 72 is guided along the inner circumferential surface of the housing body 100 and the inner circumferential surface of the coolant material 60 disposed on the side surface of the bottom container 120. The lower portion 72 is integrally connected to a lower end side of the upper portion 71. The axis of the substantially circular columnar shape of the upper portion 71 and the axis of the substantially circular columnar shape of the lower portion 72 are coaxial. The outer diameter of the upper portion 71 is smaller than the outer diameter of the lower portion 72. The axis of the substantially cylindrical tubular shape of the rod portion 42 of the first projectile 40 and the axis of the upper portion 71 (or the lower portion 72) of the second projectile 70 are arranged coaxially. Here, the lower portion 72 in the present embodiment has a substantially circular columnar shape, but the shape thereof is not particularly limited.

The lower end surface 421 of the rod portion 42 of the first projectile is disposed facing the upper end surface of the lower portion 72 of the second projectile in a state where the second projectile 70 is disposed at the initial position illustrated in FIG. 1. The lower end surface of the lower portion 72 of the second projectile 70 is disposed facing the cutoff portion 53 in a state where the second projectile 70 is disposed at the initial position illustrated in FIG. 1. The lower end surface of the lower portion 72 is formed as a cutting surface for cutting off the cutoff portion 53 from the conductor piece 50 during actuation of the breaker device 1.

The upper end surface of the second projectile 70 is formed as a second pressure receiving portion 73 that receives energy received from the igniter 20 during actuation of the breaker device 1 (the igniter 20). The lower end surface of the second projectile 70 is formed as a pressing portion 74 for pressing the cutoff portion 53 cut off by the second projectile 70 into the arc-extinguishing region R2 during actuation of the breaker device 1 (the igniter 20). That is, the lower end surface of the lower portion 72 is a cutting surface for cutting off the cutoff portion 53 and the pressing portion 74 for pressing the cutoff portion 53 that has been cut off into the arc-extinguishing region R2. Here, when the second projectile 70 is attached to the first projectile 40, the upper portion 71 of the second projectile 70 is inserted into the attachment recessed portion 45 of the first projectile 40 from the second pressure receiving portion 73 (upper surface) side. As a result, as illustrated in FIG. 1, the second projectile 70 is attached to the first projectile 40 and thus the pressing portion 74 is disposed on an open end 45A side of the attachment recessed portion 45 while the second pressure receiving portion 73 of the second projectile 70 faces the communication path 46 and the recess 44 in the first projectile 40. In the present embodiment, the second projectile 70 is disposed coaxially with the first projectile 40 in a state of being attached to the attachment recessed portion 45. However, the second projectile 70 may be decentered with respect to the first projectile 40 in a state where the second projectile 70 is attached to the first projectile 40.

In the present embodiment, the axial depth of the attachment recessed portion 45 in the first projectile 40 is larger than the axial length of the second projectile 70. The axial depth of the attachment recessed portion 45 in the first projectile 40 may be equal in dimension to the axial length of the upper portion 71 of the second projectile 70. By inserting the upper portion 71 of the second projectile 70 into the attachment recessed portion 45 of the first projectile 40, the second projectile 70 can reach the coolant material 60 of the bottom wall portion 123 of the bottom container 120 straight and stably during actuation.

The projectile 30 configured as described above is disposed in the projectile initial arrangement region R1 of the accommodating space 13 in a state where the upper portion 71 of the second projectile 70 is attached to the attachment recessed portion 45 of the first projectile 40 in the pre-actuation initial state illustrated in FIG. 1. In the example illustrated in FIG. 1, the piston portion 41 of the first projectile 40 is positioned on the first end portion 11 side (upper end side) in the accommodating space 13. The lower portion 72 of the second projectile 70 is disposed in a state where the lower end surface is placed on the conductor piece 50. Note that the reference sign L1 shown in FIG. 2 indicates an outer circumferential position of the lower portion 72 of the second projectile 70 positioned on the conductor piece 50 in a state of being attached to the housing body 100 of the breaker device 1. In the pre-actuation initial state of the breaker device 1, the outer circumferential position L1 of the lower portion 72 of the second projectile 70 substantially overlaps the positions of the notches 54 positioned at both ends of the cutoff portion 53. Further, before actuation of the igniter 20, the second projectile 70 is attached to the first projectile 40 and thus a center axis C1 of the second projectile 70 passes through the vicinity of the center position of the cutoff portion 53.

### Operation

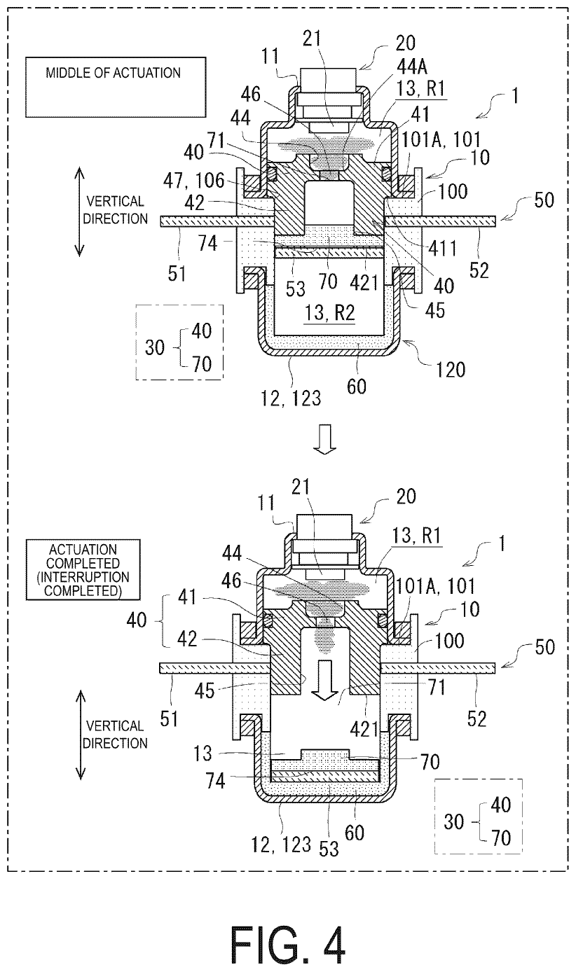

Next, details of operation when the breaker device 1 is actuated to interrupt the electric circuit will be described. FIG. 4 is a view illustrating an actuation situation of the breaker device 1 according to the embodiment. The upper half of FIG. 4 illustrates a situation in the middle of actuation of the breaker device 1, and the lower half of FIG. 4 illustrates a situation in which the actuation of the breaker device 1 is completed. Hereinafter, details of the operation of the breaker device 1 during actuation will be described with reference to FIGS. 3 and 4.

The breaker device 1 according to the present embodiment further includes an abnormality detection sensor (not illustrated) that detects an abnormal current of the electric circuit, and a control unit (not illustrated) that controls the actuation of the igniter 20. In addition to the current flowing through the conductor piece 50, the abnormality detection sensor may be capable of detecting a voltage and a temperature of the conductor piece 50. Further, the control unit of the breaker device 1 is a computer capable of performing a predetermined function by executing a predetermined control program, for example. The predetermined function of the control unit may be realized by corresponding hardware. When an excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the conduction pins of the igniter 20 and actuates the igniter 20 based on the current value detected by the abnormality detection sensor. Here, the abnormal current may be a current value that exceeds a predetermined threshold value set for protection of a predetermined electric circuit. Note that the abnormality detection sensor and the control unit described above need not be included in the constituent elements of the breaker device 1, and may be included in a device separate from the breaker device 1, for example. Further, the abnormality detection sensor and the control unit are not essential components of the breaker device 1.

For example, when an abnormal current of the electric circuit is detected by an abnormality detection sensor that detects an abnormal current of the electric circuit, the control unit of the breaker device 1 actuates the igniter 20. That is, an actuating current is supplied from the external power source (not illustrated) to the conduction pins of the igniter 20, and as a result, the ignition charge in the ignition portion 21 is ignited and burns, generating a combustion gas. Then, the rupture surface 21A ruptures due to rise in pressure in the ignition portion 21, and the combustion gas of the ignition charge is discharged from the inside of the ignition portion 21 into the accommodating space 13.

As described above, the projectile 30 in the breaker device 1 includes the first projectile 40 and the second projectile 70. The projectile 30 is configured to be projected from the initial position by receiving energy received from the igniter 20 during actuation, more specifically, energy of the combustion gas generated by combustion of the ignition charge in the ignition portion 21, and is movable along the accommodating space 13. The first projectile 40 and the second projectile 70 in the projectile 30 have functions (roles) different from each other. Specifically, the first projectile 40 functions to press the second projectile 70 into the arc-extinguishing region R2 by being projected toward the second end portion 12 in the accommodating space 13 by energy received from the combustion gas of the ignition charge in the igniter 20 during actuation of the breaker device 1 (the igniter 20). On the other hand, the second projectile 70 functions to cut off the cutoff portion 53 from the conductor piece 50 and press the cutoff portion 53 having been cut off into the arc-extinguishing region R2 by being projected toward the second end portion 12 in the accommodating space 13 by energy received from the combustion gas of the ignition charge in the igniter 20 during actuation of the breaker device 1 (the igniter 20). Hereinafter, details of the operation of the first projectile 40 and the second projectile 70 during actuation of the breaker device 1 (igniter 20) will be described.

As illustrated in FIG. 1, the ignition portion 21 of the igniter 20 is received in the recess 411 of the piston portion 41 of the first projectile 40, and the rupture surface 21A of the ignition portion 21 is disposed facing the first pressure receiving portion 44A of the recess 411 in the first projectile 40. Therefore, the combustion gas from the ignition portion 21 is discharged toward the recess 411 of the first projectile 40, and the pressure (combustion energy) of the combustion gas is transmitted to the upper surface of the piston portion 41 including a pressure receiving surface 411A. Due to this, the upper surface of the piston portion 41 including the pressure receiving surface 411A in the first projectile 40 is pressed, and the first projectile 40 is vigorously biased downward (toward the second end portion 12 side). As a result, the lower end surface of the second projectile 70 disposed below the first projectile 40 is strongly pressed against each boundary portion (site where the notches 54 are formed) between each of the first connecting end portion 51 and the second connecting end portion 52 and the cutoff portion 53 of the conductor piece 50. In this manner, for example, the cutoff portion 53 of the conductor piece 50 is pressingly cut by shearing, whereby the cutoff portion 53 can be cut off from the conductor piece 50.

As illustrated in the upper half of FIG. 4, the first projectile 40 moves downward (toward the second end portion 12 side) in the extending direction (axial direction) of the accommodating space 13 by a predetermined stroke until a lower end surface 411 of the piston portion 41 abuts (collides with) the upper surface 101 of the housing body 100. A state where the lower end surface 411 of the piston portion 41 abuts (collides with) a stopper portion 101A on the upper surface 101 of the housing body 100 in this manner and thereby restricts the first projectile 40 from moving further downward (toward the second end portion 12 side) is referred to as the “movement restriction state”. As illustrated in the upper half of FIG. 4, in the breaker device 1 according to the present embodiment, the length of the rod portion 42 or the dimension in the vertical direction of the arc-extinguishing region R2 is set, and thus the lower end surface 421 of the rod portion 42 is positioned in a relatively upper region of the arc-extinguishing region R2 when the first projectile 40 is projected from the initial position during actuation and reaches the movement restriction state. The position of the first projectile 40 when the first projectile 40 is projected from the initial position during actuation and reaches the movement restriction state is the stop position of the first projectile 40. During actuation, the first projectile 40 reaches and stops at the stop position.

Note that a holding portion for holding the lower end surface 411 of the piston portion 41 in a state of abutting the stopper portion 101A when the lower end surface 411 of the piston portion 41 in the first projectile 40 collides with the stopper portion 101A during actuation of the breaker device 1 may be provided on at least any one of the lower end surface 411 of the piston portion 41 or the stopper portion 101A. Such a holding portion is not particularly limited. For example, the holding portion may be formed by a protrusion provided on the lower end surface 411 of the piston portion 41 or the stopper portion 101A. For example, when the lower end surface 411 of the piston portion 41 collides with the stopper portion 101A, a protrusion provided on the lower end surface 411 of the piston portion 41 pierces the stopper portion 101A, or a protrusion provided on the stopper portion 101A pierces the lower end surface 411 of the piston portion 41, whereby the lower end surface 411 of the piston portion 41 can be held in a state of abutting the stopper portion 101A. Alternatively, the holding portion may be formed not by actively providing the protrusion as described above, but by engagement between a round internal corner portion 47 formed at a boundary portion between the lower end surface 411 of the piston portion 41 and the outer circumferential surface of the rod portion 42 as illustrated in FIG. 1, and a right angle external corner portion 106 formed by the 101A (upper surface 101) and the inner circumferential surface of the housing body 100 connected at a right angle. In this case, when the lower end surface 411 of the piston portion 41 collides with the stopper portion 101A during actuation of the breaker device 1, the lower end surface 411 of the piston portion 41 may be held in a state of abutting the stopper portion 101A, with the right angle external corner portion 106 biting (piercing) the round internal corner portion 47 to be engaged therewith.

Next, the operation of the second projectile 70 during actuation of the breaker device 1 (igniter 20) will be described. As described above, in the pre-actuation initial state of the breaker device 1, the upper portion 71 of the second projectile 70 is attached to the attachment recessed portion 45 of the first projectile 40. As described above, the recess 44 and the attachment recessed portion 45 in the first projectile 40 communicate with each other via the communication path 46, and the second pressure receiving portion 73 of the second projectile 70 in the state of being attached to the first projectile 40 is disposed facing the lower end of the communication path 46. Therefore, part of the combustion gas from the ignition portion 21 discharged toward the recess 411 of the first projectile 40 during actuation of the breaker device 1 (the igniter 20) is guided to the second pressure receiving portion 73 of the second projectile 70 through the communication path 46, and as a result, the pressure (combustion energy) of the combustion gas is transmitted to the second pressure receiving portion 73 of the second projectile 70. Due to this, the second pressure receiving portion 73 of the second projectile 70 attached (accommodated) in the attachment recessed portion 45 of the first projectile 40 is pressed, and the second projectile 70 is vigorously biased downward (toward the second end portion 12 side). As a result, the second projectile 70 stored in the attachment recessed portion 45 of the first projectile 40 protrudes downward from the open end 45A of the attachment recessed portion 45 and is projected. Due to this, as illustrated in the upper half of FIG. 4, by pressing, downward by the pressing portion 74 of the second projectile 70, the cutoff portion 53 cut off from the conductor piece 50 by the lower end surface of the second projectile 70, it is possible to press the cutoff portion 53 toward the bottom portion side (i.e., the second end portion 12 side) of the arc-extinguishing region R2 as illustrated in the lower half of FIG. 4.

As described above, the projectile 30 of the breaker device 1 according to the present embodiment includes the first projectile 40 and the second projectile 70, which are projected in two steps by receiving energy of the combustion gas generated by the burning of the ignition charge of the ignition portion 21 during actuation of the igniter 20. That is, the first projectile 40 and the second projectile 70 projected by energy received from the combustion gas of the ignition charge during actuation of the igniter 20 are pressed down toward the second end portion 12 side of the accommodating space 13, whereby it is possible to press and cut the cutoff portion 53 by the second projectile 70 and cut off the cutoff portion 53 from the conductor piece 50. As a result, the first connecting end portion 51 and the second connecting end portion 52 positioned at both ends of the conductor piece 50 are electrically disconnected, and the predetermined electric circuit to which the breaker device 1 is applied can be forcibly interrupted.

Then, similarly to the first projectile 40, the second projectile 70 is projected from the first projectile 40 toward the second end portion 12 side by the energy received from the combustion gas of the ignition charge generated during actuation of the igniter 20. Due to this, the cutoff portion 53 can be quickly pressed toward the bottom portion side (the second end portion 12 side) of the arc-extinguishing region R2 by the pressing portion 74 (lower end surface) of the second projectile 70. As a result, the cutoff portion 53 pressed toward the bottom portion side of the arc-extinguishing region R2 by the second projectile 70 is rapidly cooled by the coolant material 60 disposed in the arc-extinguishing region R2, whereby the arc generated when the cutoff portion 53 is cut off from the first connecting end portion 51 and the second connecting end portion 52 can be quickly extinguished. As a result, it is possible to quickly interrupt the electric circuit to which the breaker device 1 is applied in a case where an abnormality is detected in the electric circuit, or the like. That is, by effectively suppressing a prolonged extinguishing of the arc generated when the electric circuit is interrupted, it is possible to suppress a prolonged interruption of the electric circuit. In the breaker device 1, it is possible to suitably suppress generation of a large spark or flame or generation of a large impact sound when the electric circuit is interrupted. Further, damage to the housing 10 and the like of the breaker device 1 caused by these can also be suppressed.

As described above, the breaker device 1 includes the second projectile 70 that is projected from the first projectile 40 to press the cutoff portion 53 cut off by the second projectile 70 toward the bottom portion side (the second end portion 12 side) of the arc-extinguishing region R2, separately from the first projectile 40, during actuation of the igniter 20. By adopting such a two-step mechanism in the projectile 30, even if an axial length of the rod portion 42 in the first projectile 40 is designed to be short, the second projectile 70 can separate the cutoff portion 53 from the cutting surface 421 of the first projectile 40 and press the cutoff portion 53 toward the bottom portion side (second end portion 12 side) of the arc-extinguishing region R2. Due to this, the cutoff portion 53 after being cut off can be swiftly moved away from the first connecting end portion 51 and the second connecting end portion 52 in the conductor piece 50, the arc when the electric circuit is interrupted can be reduced, and the insulation performance thereof can be improved.

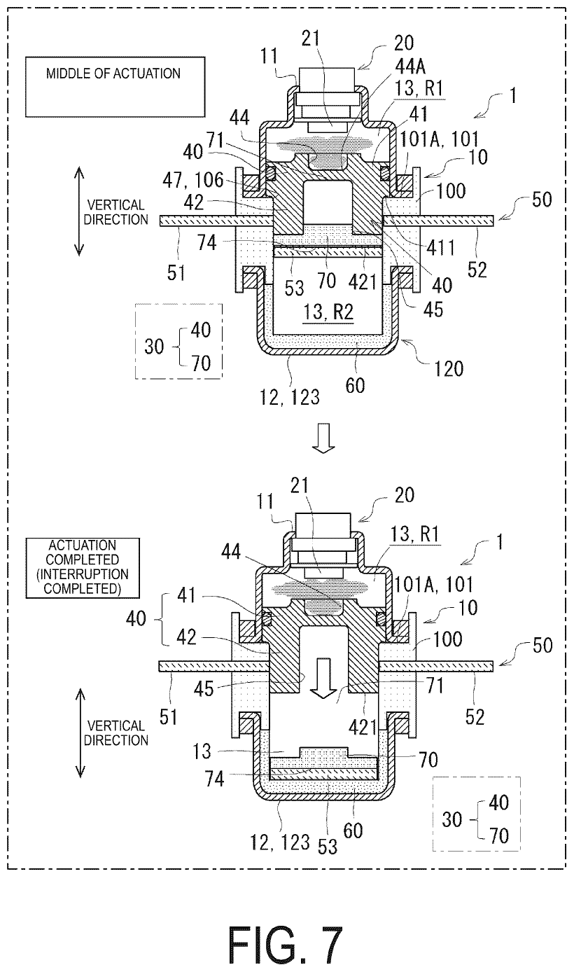

FIG. 7 is a view illustrating an actuation situation of the breaker device 1 in a case where no communication path exists, and is similar to FIG. 4 except for the presence or absence of the communication path. In a case where the communication path 46 does not exist, the second pressure receiving portion 73 (upper end surface) of the second projectile 70 does not receive energy received from the igniter 20 during actuation of the breaker device 1 (the igniter 20). However, the second projectile 70 is pressed into the arc-extinguishing region R2 together with the first projectile 40 by being projected toward the second end portion 12 in the accommodating space 13 by energy received from the combustion gas of the ignition charge in the igniter 20 during actuation of the breaker device 1 (the igniter 20). When the lower end surface 411 of the piston portion 41 in the first projectile 40 collides with the stopper portion 101A, the first projectile 40 stops, but the second projectile 70 is separated from the first projectile 40 and vigorously protrudes downward (toward the second end portion 12 side). Due to this, similarly to the case where the communication path 46 exists, the cutoff portion 53 can be quickly pressed toward the bottom portion side (the second end portion 12 side) of the arc-extinguishing region R2 by the pressing portion 74 (lower end surface) of the second projectile 70.

On the other hand, in the known breaker device without the two-step projection mechanism of the projectile, in order to increase the distance between the conductor piece and the cut portion, a movement stroke of the projectile corresponding to the distance by which the cut portion should be separated from the conductor piece is normally required, and therefore, the axial length of the projectile has to be increased in accordance with the movement stroke. On the other hand, the axial length of the rod portion 42 in the first projectile 40 according to the present embodiment only needs to have a length sufficient to press the second projectile 70 and cut off the cutoff portion 53 during actuation of the igniter 20, and it is not necessary to press the cutoff portion 53 by the rod portion 42 toward the bottom portion side of the arc-extinguishing region R2. For example, the axial length of the rod portion 42 in the first projectile 40 may be set to a length such that when the piston portion 41 reaches the movement restriction state during actuation of the igniter 20, the position of the lower end surface of the second projectile 70 is positioned lower than the position of the lower surface (the surface facing the arc-extinguishing region R2) of the cutoff portion 53 in the pre-actuation initial state. Due to this, while the axial length of the rod portion 42 in the first projectile 40 is shortened, the cutoff portion 53 can be cut off at the time of projection, and the cutoff portion 53 after being cut off can be swiftly separated away from the first connecting end portion 51 and the second connecting end portion 52. Thus, being able to shorten the axial length of the rod portion 42 and, by extension, the axial length of the first projectile 40 has the following advantages.

That is, in the pre-actuation initial state of the breaker device 1, as illustrated in FIG. 1, the projectile 30 is disposed above the cutoff portion 53 of the conductor piece 50 in the projectile initial arrangement region R1, that is, the accommodating space 13. Therefore, as the axial length of the first projectile 40 increases, it is necessary to increase the axial length of the projectile initial arrangement region R1, and it is necessary to increase the height dimension of the housing 10. On the other hand, in the breaker device 1 of the present embodiment, since the axial length of the first projectile 40 (rod portion 42) can be shortened, the height dimension of the housing 10 can be reduced. As described above, in the breaker device 1 of the present embodiment, it is possible to obtain an effect of improving the insulation performance (an effect of reducing the arc) when the electric circuit is interrupted while achieving downsizing of the entire housing 10.

Note that in the breaker device 1, the timing at which the second projectile 70 is projected from the first projectile 40 during actuation of the igniter 20 is not particularly limited. For example, the second projectile 70 may be projected from the first projectile 40 at the moment when the cutoff portion 53 is removed by the lower end surface of the second projectile 70, or as illustrated in the upper half of FIG. 4, the second projectile 70 may be projected from the first projectile 40 at the timing after reaching the movement restriction state where the lower end surface 411 of the piston portion 41 abuts (collides with) the stopper portion 101A of the housing body 100. Alternatively, the second projectile 70 may be projected from the first projectile 40 at the timing in the process (middle) of reaching the movement restriction state after the second projectile 70 removes the cutoff portion 53 during actuation of the igniter 20.

Furthermore, in the breaker device 1, as described above, the second projectile 70 is attached to the first projectile 40 prior to actuation of the igniter 20 (pre-actuation initial state) and is configured to be projected from the first projectile 40 by the energy received from the igniter 20. According to this, the second projectile 70 can have a reasonable arrangement aspect suitable for pressing the cutoff portion 53 after cutoff toward the bottom portion side (the second end portion 12 side) of the arc-extinguishing region R2.

Furthermore, in the present embodiment, since the second projectile 70 is smaller in size than the first projectile 40, it is possible to reduce the impact when the cutoff portion 53 cut off during actuation of the breaker device 1 collides with the bottom wall portion 123 of the bottom container 120. Therefore, even if the thickness of the bottom wall portion 123 in the bottom container 120 is reduced, deformation, damage, and the like of the bottom wall portion 123 can be suppressed. However, the aspect of the second projectile 70 is not particularly limited as long as the cutoff portion 53 cut off during actuation of the igniter 20 can be pressed into the arc-extinguishing region R2. For example, the second projectile 70 may be disposed in a state of being spaced apart from the first projectile 40 without being attached to the first projectile 40 in the pre-actuation initial state. Further, it is not necessary for the second projectile 70 to be smaller in size than the first projectile 40. The second projectile 70 may have a size equal to that of the first projectile 40, or the second projectile 70 may be larger in size than the first projectile 40.

Further, in the breaker device 1, the second projectile 70 is attached to the first projectile 40 with the second projectile 70 positioned coaxially with the first projectile 40. Accordingly, when the second projectile 70 is projected from the first projectile 40, the second projectile 70 can press the cutoff portion 53 toward the bottom portion side (the second end portion 12 side) of the arc-extinguishing region R2 in a well-balanced manner. Since the diameter of the lower portion 72 of the second projectile 70 is slightly smaller than the inner diameter of the inner circumferential surface of the coolant material 60 disposed on the side surface of the bottom container 120, rebound of the second projectile 70 at the bottom portion of the arc-extinguishing region R2 can be suppressed. Furthermore, since the rebound of the second projectile 70 is suppressed, the second projectile 70 can press and hold the cutoff portion 53 having been cut off into the coolant material 60 at the bottom portion of the bottom container 120. Since the diameter of the lower portion 72 of the second projectile 70 is slightly smaller than the inner diameter of the inner circumferential surface of the coolant material 60 disposed on the side surface of the bottom container 120, the second projectile 70 becomes less likely to move in a direction other than the vertical direction, and the cutoff portion 53 having been cut off becomes easily pressed into the coolant material 60 at the bottom portion of the bottom container 120.

The first projectile 40 in the present embodiment includes the lower end surface 421, the attachment recessed portion 45 opening in the cutting surface 421 and being used for attaching the second projectile 70, and the communication path 46 for guiding energy received from the igniter 20 to the second pressure receiving portion 73 of the second projectile 70 attached to the attachment recessed portion 45. According to this, the combustion gas generated during actuation of the igniter 20 can be suitably introduced via the communication path 46 into the second pressure receiving portion 73 of the second projectile 70 attached to the attachment recessed portion 45 of the first projectile 40. Then, the second projectile 70 can be smoothly projected from the first projectile 40 by the pressure (combustion energy) of the combustion gas introduced into the second pressure receiving portion 73.

While the embodiment of the electric circuit breaker device according to the present disclosure has been described above, each of the aspects disclosed in the present specification can be combined with any other feature disclosed in the present specification.

### REFERENCE SIGNS LIST

1 Breaker device
10 Housing
13 Accommodating space
20 Igniter
30 Projectile
40 First projectile
50 Conductor piece
53 Cutoff portion
60 Coolant material
70 Second projectile

1. An electric circuit breaker device comprising:
an igniter provided in a housing;
a projectile formed in the housing and disposed in an accommodating space extending in one direction, the projectile being configured to be projected along the accommodating space by energy received from the igniter;
a conductor piece provided in the housing and forming a portion of an electric circuit, the conductor piece including, in a part of the conductor piece, a cutoff portion disposed crossing the accommodating space and configured to be cut off by the projectile; and
an arc-extinguishing region provided in the accommodating space and provided with a coolant material, wherein
the projectile includes
a first projectile configured to be projected by energy received from the igniter and reach a stop position, and a second projectile configured to be separated from the first projectile, cut off the cutoff portion from the conductor piece, and press, into the coolant material disposed in the arc-extinguishing region, the cutoff portion having been cut off.

2. The electric circuit breaker device according to claim 1, wherein
the second projectile is attached to the first projectile prior to actuation of the igniter, and is projected together with the first projectile by energy received from the igniter.

3. The electric circuit breaker device according to claim 2, wherein
the second projectile is attached to the first projectile with the second projectile positioned coaxially with the first projectile, prior to actuation of the igniter.

4. The electric circuit breaker device according to claim 2, wherein
the first projectile includes an attachment recessed portion in which the second projectile is attached, and
the second projectile has a cutting surface disposed facing the cutoff portion prior to actuation of the igniter, the cutting surface being used to cut the cutoff portion.

5. The electric circuit breaker device according to claim 4, wherein
the first projectile includes a communication path through which energy received from the igniter is guided to a pressure receiving portion of the second projectile attached in the attachment recessed portion.

6. The electric circuit breaker device according to claim 3, wherein
the first projectile includes an attachment recessed portion in which the second projectile is attached, and
the second projectile has a cutting surface disposed facing the cutoff portion prior to actuation of the igniter, the cutting surface being used to cut the cutoff portion.
